(19) United States
(12) Patent Application Publication
(10) Pub. No.: US 2026/0066799 A1
(43) Pub. Date: Mar. 5, 2026

(54) POWER CONVERSION DEVICE

(71) Applicant: YAZAKI CORPORATION, Tokyo (JP)

(72) Inventors: Hideaki Kikuchi, Susono-shi (JP); Hiroyuki Ogura, Susono-shi (JP)

(21) Appl. No.: 19/312,583

(22) Filed: Aug. 28, 2025

(30) Foreign Application Priority Data
Aug. 28, 2024 (JP) 2024-146316

(51) Int. Cl. H02M 3/158; H02M 1/00

(52) U.S. Cl. CPC H02M 3/1584; H02M 1/0003

(57) ABSTRACT

A power conversion device is configured to be connected between a first voltage subsystem with a first power supply and a second voltage subsystem having a voltage which is different from a voltage of the first voltage subsystem, wherein the power conversion device includes: three or more power converting sections connected in parallel between the first voltage subsystem and the second voltage subsystem; and wherein each of the three or more power converters is configured to be connected to the first power supply via a first switch, and wherein the three or more power converting sections have maximum converted capacity values which are different from each other.

### BACKGROUND OF THE INVENTION

### Technical Field

The present invention relates to a power conversion device.

### Background Art

Electric vehicles include a high-voltage battery for driving an electric motor. Automobiles are increasingly equipped with more electric/electronic devices, and auxiliary devices which are driven with a low voltage have an increased power consumption. For the above reason, technologies have been developed in which a power provided by a high-voltage battery is converted into a power with a lower voltage by a DC/DC converter to provide the converted power to one or more auxiliary devices with such a low voltage (e.g. Patent Document 1).

### CITATION LIST

### Patent Literature

Patent Document 1: JP 2019-161839 A

### SUMMARY OF THE INVENTION

A power consumption in a low-voltage subsystem may be substantially decreased during parking as compared with a power consumption during driving the automobile. When a DC/DC converter which has a high conversion efficiency at a power consumption during driving the automobile is used also during parking with a low power consumption, this may result in a decreased conversion efficiency of the DC/DC converter.

An objective of the present invention is to provide a power conversion device with a high conversion efficiency.

In order to achieve the above objective, a power conversion device according to embodiments of the present invention is configured to be connected between a first voltage subsystem and a second voltage subsystem, wherein the first voltage subsystem includes a first power supply and the second voltage subsystem has a voltage which is different from a voltage of the first voltage subsystem, the power conversion device including: three or more power converting sections connected in parallel between the first voltage subsystem and the second voltage subsystem; and first switches; wherein each of the three or more power converters is configured to be connected to the first power supply via one of the first switches, and wherein the three or more power converting sections have maximum converted capacity values which are different from each other.

The present invention enables a power conversion device to be provided which has a high conversion efficiency.

### BRIEF DESCRIPTION OF THE DRAWINGS

FIG. 1 shows a power conversion device 100 according to an embodiment of the present invention;

FIG. 2 shows a relation between a status of each of first switches S1A, SIB and SIC and a maximum converted capacity value of the power conversion device 100;

FIG. 3 shows a relation between a power consumption in a second voltage subsystem, different threshold values, and control of the first switches S1;

FIG. 4 shows an example of operation in a control section 120; and

FIG. 5 shows an example of power conversion device 100.

### DETAILED DESCRIPTION OF THE PREFERRED EMBODIMENTS

### <Power Conversion Device 100>

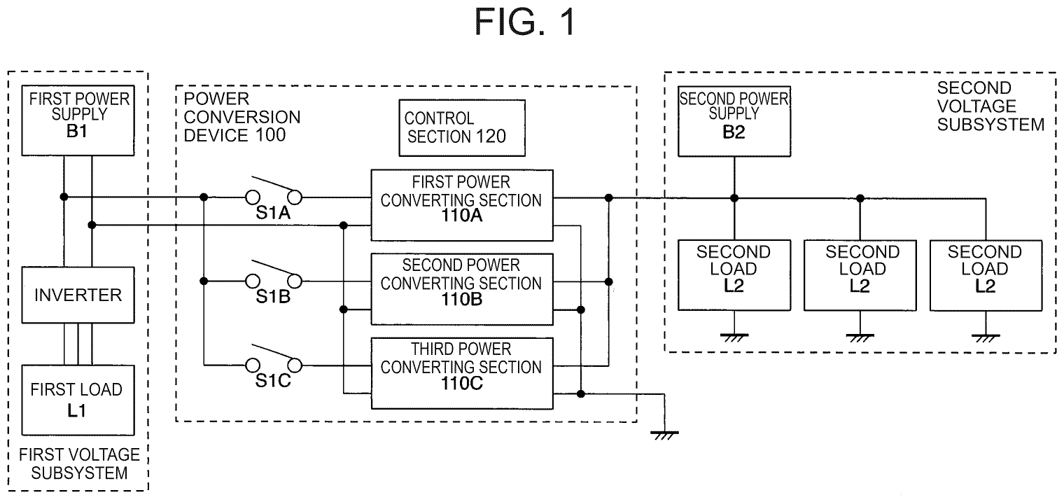

FIG. 1 shows a power conversion device 100 according to an embodiment of the present invention. The power conversion device 100 is formed by one or more DC/DC converters and is connected between a first voltage subsystem and a second voltage subsystem. The second voltage subsystem has a voltage which is different from a voltage of the first voltage subsystem, wherein the power conversion device 100 receives a power as an input from the first voltage subsystem, converts the power from the voltage of the first voltage subsystem into the voltage of the second voltage subsystem and then provides the power with the converted voltage as an output to the second voltage subsystem. For example, the second voltage subsystem has a lower voltage than the first voltage subsystem, wherein the power conversion device 100 receives a power as the input from the first voltage subsystem, converts a voltage of the power from the voltage of the first voltage subsystem into the voltage of the second voltage subsystem and then provides the power with the decreased voltage as an output to the second voltage subsystem.

The first voltage subsystem includes a first power supply B1 which supplies the power to the first voltage subsystem, wherein the power conversion device 100 converts the supplied power from the first power supply B1 into a power with the voltage of the second voltage subsystem for providing the converted power to the second voltage subsystem. The first power supply B1 is e.g. an accumulator. As shown in FIG. 1, the first voltage subsystem may include one or more first loads L1 (e.g., motors) driven by the voltage of the first voltage subsystem. This first load L1 may be connected to the first power supply B1 via an inverter, as shown in FIG. 1.

The second voltage subsystem includes a plurality of second loads L2 which are configured to be driven by the voltage of the second voltage subsystem. The second voltage subsystem may further include a second power supply B2 that is configured to provide the voltage of the second voltage subsystem. The second power supply B2 is e.g. an accumulator.

The power conversion device 100 includes three or more power converting sections 110 and a control section 120. According to the example shown in FIG. 1, the power conversion device 100 includes a first power converting section 110A, a second power converting section 110B, and a third power converting section 110C as the three or more power converting sections 110.

Each of the three or more power converting sections 110 is connected in parallel between the first voltage subsystem and the second voltage subsystem. Each of the three or more power converting sections 110 is configured as an isolated DC/DC converter that receives a power as an input from the first voltage subsystem, converts the received power from the voltage of the first voltage subsystem to the voltage of the second voltage subsystem and outputs this converted power to the second voltage subsystem. Each of the three or more power converting sections 110 may be formed by a single isolated DC/DC converter, or may be formed by two or more isolated DC/DC converters, as detailed below.

Each of the three or more power converting sections 110 is connected to the first power supply B1 via a first switch S1. In other words, the power conversion device 100 includes a plurality of switches S1, wherein each of the plurality of switches S1 is associated with one of the three or more power converting sections 110 in a one-to-one manner. According to the example shown in FIG. 1, the first power converter 110A is associated with a first switch S1A and connected to the first power supply B1 via this associated first switch S1A. The second power converter 110B is associated with a first switch S1B and connected to the first power supply B1 via this associated first switch S1B. The third power converter 110C is associated with a first switch S1C and is connected to the first power supply B1 via this associated first switch S1C.

The three or more power converting sections 110 have maximum converted capacity values which are different from each other. In this case, the maximum converted capacity values of the three or more power converting sections may be preferably integer multiples of a predetermined capacity value (basic capacity value). According to the example shown in FIG. 1, a maximum converted capacity value of the first power converting section 110A is equal to the basic capacity value, wherein a maximum converted capacity value of the second power converting section 110B is twice as large as the basic capacity value, while a maximum converted capacity value of the third power converting section 110C is four times as large as the basic capacity value.

The control section 120 controls the first switches S1 based on a power consumption value in the second voltage subsystem. According to the present embodiment, the power consumption value in the second voltage subsystem may be changed based on which of the plurality of second loads L2 included in the second voltage subsystem is operated. In other words, according to the present embodiment, the power consumption value in the second voltage subsystem is determined based on the power consumption value of one or more of the plurality of second loads L2 which are being operated.

Therefore, the control section 120 may preferably acquire information about start and end of operation of the second loads L2 and calculate the power consumption in the second voltage subsystem based on this acquired information about the start and end of the operation. For example, when information about start of operation of the second load L2 is acquired by the control section 120, the number of second loads L2 is increased which are being operated, and therefore, the power consumption in the second voltage subsystem is increased. When information about end of operation of the second load L2 is acquired by the control section 120, the number of second loads L2 is decreased which are being operated, and therefore, the power consumption in the second voltage subsystem is decreased.

In addition, the control section 120 may be configured to measure the power consumption value in the second voltage subsystem.

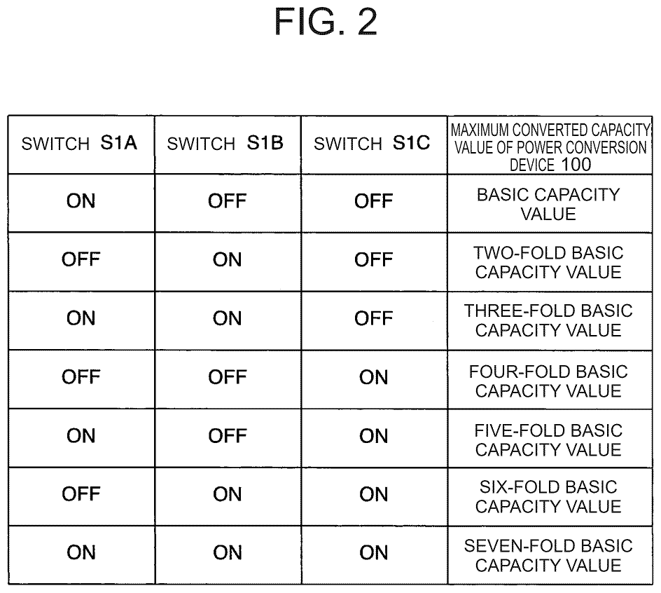

According to the present embodiment, the three or more power converting sections 110 have maximum converted capacity value which are different from each other. Accordingly, the maximum converted capacity value may vary depending on a combination of power converting sections 110 which are used. In other words, as shown in FIG. 2, the maximum converted capacity value of the power conversion device 100 may vary depending on the states of the first switches.

According to the example shown in FIG. 1, there are seven combinations of power converting sections 110 which are used, namely, only the first power converting section 110A, only the second power converting section 110B, only the third power converting section 110C, a combination of the first power converting section 110A and the second power converting section 110B, a combination of the second power converting section 110B and the third power converting section 110C, a combination of the first power converting section 110A and the third power converting section 110C, and a combination of the first power converting section 110A, the second power converting section 110B, and the third power converting section 110C.

When the first switch S1A associated with the first power converting section 110A is switched on and the first switches S1B and SIC associated with the second power converting section 110B and the third power converting section 110C are switched off, namely when only the first power converting section 110A is used, the maximum converted capacity value of the power conversion device 100 is equal to the basic capacity value, which is the maximum converted capacity value of the first power converting section 110A.

When the first switch S1B associated with the second power converting section 110B is switched on and the first switches S1A and SIC associated with the first power converting section 110A and the third power converting section 110C are switched off, namely when only the second power converting section 110B is used, the maximum converted capacity value of the power conversion device 100 is equal to the maximum converted capacity value of the second power converting section 110B (twice as large as the basic capacity value).

When the first switches S1A and SIB associated with the first power converting section 110A and the second power converting section 110B are switched on and the first switch S1C associated with the third power converting section 110C is switched off, namely when only the first power converting section 110A and the second power converting section 110B are used, the maximum converted capacity value of the power conversion device 100 is equal to a sum of the maximum converted capacity values of the first power converting section 110A and the second power converting section 110B (third times as large as the basic capacity value).

When the first switch S1C associated with the third power converting section 110C is switched on and the first switches S1A and SIB associated with the first power converting section 110A and the second power converting section 110B are switched off, namely when only the third power converting section 110C is used, the maximum converted capacity value of the power conversion device 100 is equal to the maximum converted capacity value of the third power converting section 110C (four times as large as the basic capacity value).

When the first switches S1A and SIC associated with the first power converting section 110A and the third power converting section 110C are switched on and the first switch S1B associated with the second power converting section 110B is switched off, namely when only the first power converting section 110A and the third power converting section 110C are used, the maximum converted capacity value of the power conversion device 100 is equal to a sum of the maximum converted capacity values of the first power converting section 110A and the third power converting section 110C (five times as large as the basic capacity value).

When the first switches S1B and SIC associated with the second power converting section 110B and the third power converting section 110C are switched on and the first switch S1A associated with the first power converting section 110A is switched off, namely when only the second power converting section 110B and the third power converting section 110C are used, the maximum converted capacity value of the power conversion device 100 is equal to a sum of the maximum converted capacity values of the second power converting section 110B and the third power converting section 110C (six times as large as the basic capacity value).

When the first switches S1A, SIB and SIC associated with the first power converting section 110A, the second power converting section 110B and the third power converting section 110C are switched on, namely when all the first switches S1A, SIB and SIC are switched on and all of the first power converting section 110A, the second power converting section 110B and the third power converting section 110C are used, the maximum converted capacity value of the power conversion device 100 is equal to a sum of the maximum converted capacity values of the first power converting section 110A, the second power converting section 110B and the third power converting section 110C (seven times as large as the basic capacity value).

In other words, according to the present embodiment, it is possible to change the maximum converted capacity value of the power conversion device 100 depending on the combination of the first switches S1 that are switched on, that is, depending on the combination of power converting sections 110 which are used. According to the example shown in FIG. 1, the power conversion device 100 includes three power converting sections 110A, 110B and 110C, and therefore, there are seven possible combinations of power converting sections 110A, 110B, and 110C as shown in FIG. 2, allowing the power conversion device 100 to take seven different values for the maximum converted capacity value.

In this manner, according to the present embodiment, the power conversion device 100 can take seven or more values for the maximum converted capacity value. Consequently, it is possible to change the maximum converted capacity value of the power conversion device 100 so that the power conversion device 100 has an increased conversion efficiency for the power consumption value of the second voltage subsystem. As a result, this embodiment enables a power conversion device with high conversion efficiency to be provided.

In general, for different maximum converted capacity values, different power consumption values (optimal operation points) exist for which the conversion efficiency is best. As mentioned above, according to the present embodiment, different maximum converted capacity values exist for different combinations of the three or more power converting sections 110. Therefore, according to the present embodiment, different optimal operation points exist for different combinations of power converting sections 110 which are used. Therefore, the control section 120 may be preferably configured to control the first switches S1 based on the power consumption in the second voltage subsystem and based on an optimal operation point for each of combinations of power converting sections which are used.

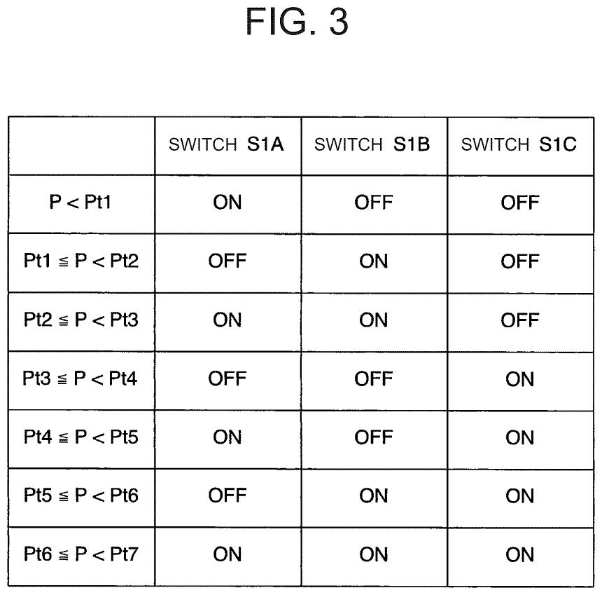

For this control, a plurality of threshold values may be preferably provided as shown in FIG. 3, wherein the control section 120 may be preferably configured to control the first switches S1 based on a relation between the power consumption in the second voltage subsystem and the plurality of threshold values. FIG. 3 corresponds to the example as shown in FIG. 1, wherein a relation is shown which exists between a power consumption P in the second voltage subsystem, different threshold values Pt1 to Pt7, and control of the first switches S1.

Each of the plurality of threshold values is associated with one of statuses of the first switches S1 (namely, one of combinations of power converting sections 110 which are used), and determined based on the maximum converted capacity value in one of statuses of the first switches S1 (namely, one of combinations of power converting sections 110 which are used). For example, for each of combinations of power converting sections 110 which are used, a threshold value associated with the combination (an upper limit value for the combination) is determined based on a maximum converted capacity value or an optimal operation point for the combination.

According to the example shown in FIG. 1, a threshold value Pt1 is associated with the case in which the first switch S1A associated with the first power converting section 110A is switched on and the first switches S1B and SIC associated with the second power converting section 110B and the third power converting section 110C are switched off, namely only the first power converting section 110A is used. Therefore, the threshold value Pt1 is determined based on the basic capacity value which is equal to the maximum converted capacity value of the first power converting section 110A or based on the optimal operation point of the first power converting section 110A.

Similarly, a threshold value Pt2 is associated with the case in which the first switch S1B associated with the second power converting section 110B is switched on and the first switches S1A and SIC associated with the first power converting section 110A and the third power converting section 110C are switched off, namely only the second power converting section 110B is used. Therefore, the threshold value Pt2 is determined based on the maximum converted capacity value of the second power converting section 110B (twice as large as the basic capacity value) or based on the optimal operation point of the first power converting section 110B.

Similarly, a threshold value Pt3 is associated with the case in which the first switches S1A and S1B associated with the first power converting section 110A and the second power converting section 110B are switched on and the first switch S1C associated with the third power converting section 110C is switched off, namely only the first power converting section 110A and the second power converting section 110B are used. Therefore, the threshold value Pt3 is determined based on the maximum converted capacity values of the combination of the first power converting section 110A and the second power converting section 110B (third times as large as the basic capacity value) or based on the optimal operation point for the combination of the first power converting section 110A and the second power converting section 110B.

Similarly, a threshold value Pt4 is associated with the case in which the first switch S1C associated with the third power converting section 110C is switched on and the first switches S1A and S1B associated with the first power converting section 110A and the second power converting section 110B are switched off, namely when only the third power converting section 110C is used. Therefore, the threshold value Pt4 is determined based on the maximum converted capacity value of the third power converting section 110C (four times as large as the basic capacity value) or based on the optimal operation point of the third power converting section 110C.

Similarly, a threshold value Pt5 is determined based on the maximum converted capacity value of the combination of the first power converting section 110A and the third power converting section 110C (five times as large as the basic capacity value) or based on the optimal operation point for the combination of the first power converting section 110A and the third power converting section 110C. A threshold value Pt6 is determined based on the maximum converted capacity value of the combination of the second power converting section 110B and the third power converting section 110C (six times as large as the basic capacity value) or based on the optimal operation point for the combination of the second power converting section 110B and the third power converting section 110C. A threshold value Pt7 is determined based on the maximum converted capacity values of the combination of the first power converting section 110A, the second power converting section 110B and the third power converting section 110C (seven times as large as the basic capacity value) or based on the optimal operation point for the combination of the first power converting section 110A, the second power converting section 110B and the third power converting section 110C.

### <Operation by the Control Section 120>

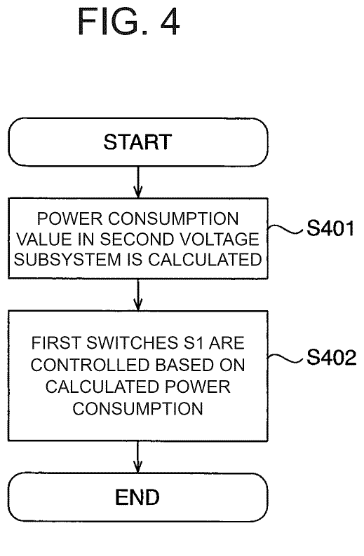

FIG. 4 shows an example of operation in the control section 120. The operation shown in FIG. 4 is performed when information about the start and end of operation of the second loads L2 included in the second voltage subsystem has been acquired.

The control section 120 calculates the power consumption in the second voltage subsystem based on the acquired information (Step S401). The control section 120 controls the first switches S1 based on the calculated power consumption and based on the optimal operation point for each of combinations of the three or more power converting sections (Step S402).

### <Power Converting Section 110>

As described above, each of the three or more power converting sections 110 may be formed by a single isolated DC/DC converter, or may be formed by two or more isolated DC/DC converters. In case where each of the three or more power converting sections 110 is formed by two or more isolated DC/DC converters, the two or more isolated DC/DC converters may preferably have a same value for the maximum converted capacity value. This enables noise cancellation to be achieved.

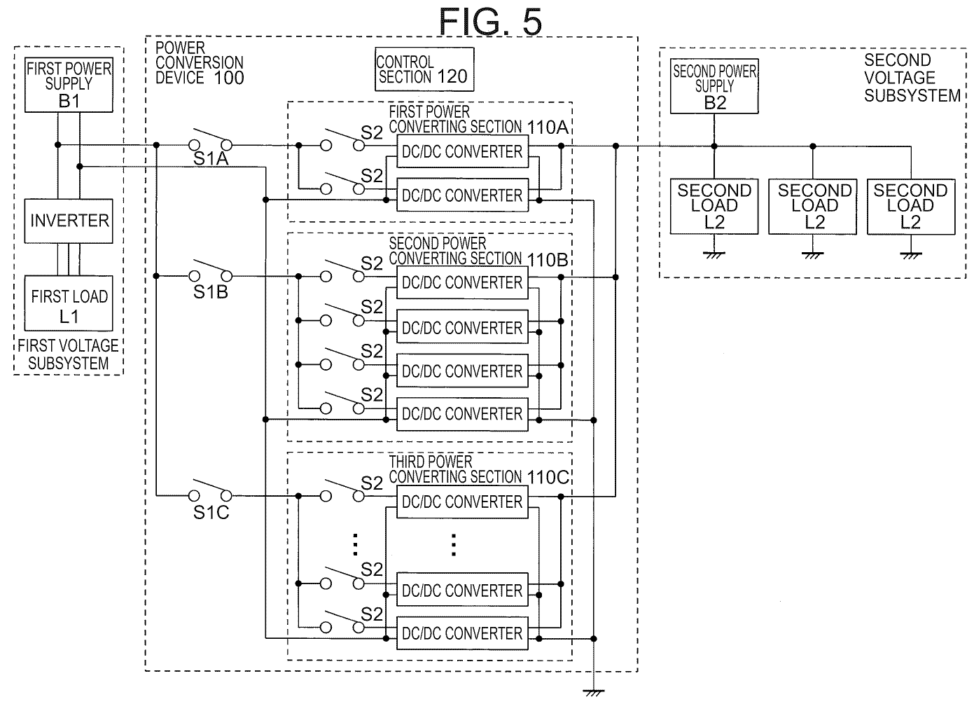

In FIG. 5, each of the first power converting section 110A, the second power converting section 110B, and the third power converting section 110C according to FIG. 1 is formed by two or more isolated DC/DC converters. According to the example shown in FIG. 5, the first power converting section 110A is formed by two DC/DC converters, wherein a maximum converted capacity value of the two DC/DC converter is a half of the basic capacity value. The second power converting section 110B is formed by four DC/DC converters, wherein a maximum converted capacity value of the four DC/DC converters is a half of the basic capacity value.

Moreover, each of the two or more isolated DC/DC converters in each of the three or more power converting sections 110 may be preferably connected to one of the first switches S1 via a second switch S2, as shown in FIG. 5. Then, the control section 120 may be preferably configured to control the first switches S1 and the second switches S2 based on the power consumption value in the second voltage subsystem.

In this manner, it is possible to change the maximum converted capacity value of the power conversion device 100 depending on the combination of the first switches S1 and the second switches S2 that are switched on, that is, depending on the combination of DC/DC converters which are used. Thus, this enables the maximum converted capacity value of the power conversion device 100 to be more finely changed so that an increased conversion efficiency of the power conversion device 100 can be obtained at the power consumption value of the second voltage subsystem.

For example, in case where the first power converting section 110A, the second power converting section 110B, and the third power converting section 110C according to the example shown in FIG. 5 are formed by two DC/DC converters, by four DC/DC converters, and by eight DC/DC converter, respectively, wherein a maximum converted capacity value of each of these DC/DC converters is a half of the basic capacity value, the power conversion device 100 may take fourteen different values of the maximum converted capacity value, i.e., a half of the basic capacity value, a value equal to the basic capacity value, three halves of the basic capacity value, twice the basic capacity value, five halves of the basic capacity value, three times the basic capacity value, seven halves of the basic capacity value, four times the basic capacity value, nine halves of the basic capacity value, five times the basic capacity value, eleven halves of the basic capacity value, six times the basic capacity value, thirteen halves of the basic capacity value, seven times the basic capacity value.

The present invention has been described above by means of the preferable embodiment thereof. Although the invention has been described herein by presenting a specific example, various modifications and changes may be made to such an example without departing from the spirit and scope of the invention as set forth in the claims.

### REFERENCE SIGNS LIST

100 Power conversion device
110 Power converting sections
110A First power converting section
110B Second power converting section
110C Third power converting section
120 Control section
S1 First switches
S2 Second switches

What is claimed is:

1. A power conversion device configured to be connected between a first voltage subsystem and a second voltage subsystem, wherein the first voltage subsystem includes a first power supply and the second voltage subsystem has a voltage which is different from a voltage of the first voltage subsystem, the power conversion device comprising:
three or more power converting sections connected in parallel between the first voltage subsystem and the second voltage subsystem; and
first switches,
wherein each of the three or more power converting sections is configured to be connected to the first power supply via one of the first switches, and
wherein the three or more power converting sections have maximum converted capacity values which are different from each other.

2. The power conversion device according to claim 1, further comprising a control section configured to control the first switches,
wherein the control section is configured to control the first switches based on a power consumption value in the second voltage subsystem.

3. The power conversion device according to claim 2,
wherein the control section is configured to control the first switches based on the power consumption value in the second voltage subsystem and based on an optimal operation point for each of combinations of the power converting sections.

4. The power conversion device according to claim 2,
wherein the maximum converted capacity values of the three or more power converting sections are integer multiples of a predetermined capacity value.

5. The power conversion device according to claim 3,
wherein the three or more power converting sections include a first power converting section, a second power converting section, and a third power converting section,
wherein a maximum converted capacity value of the first power converting section is equal to the predetermined capacity value,
wherein a maximum converted capacity value of the second power converting section is twice as large as the predetermined capacity value,
wherein a maximum converted capacity value of the third power converting section is four times as large as the predetermined capacity value.

6. The power conversion device according to claim 1,
wherein each of the three or more power converting sections is formed by a single isolated DC/DC converter.

7. The power conversion device according to claim 1,
wherein each of the three or more power converting sections is formed by two or more isolated DC/DC converters which have a same maximum converted capacity value.

8. The power conversion device according to claim 7, further comprising second switches,
wherein each of the two or more isolated DC/DC converters which form each of the three or more power converting sections is connected to one of the first switches via one of the second switches.

9. The power conversion device according to claim 7, further comprising a control section configured to control the first switches and the second switches,
wherein the control section is configured to control the first switches and the second switches based on a power consumption value in the second voltage subsystem.

10. The power conversion device according to claim 2,
wherein the control section is configured to:
acquire information about start and end of operation of a load included in the second voltage subsystem, and
calculate the power consumption value in the second voltage subsystem based on the information about the start and end of the operation.

11. The power conversion device according to claim 3,
wherein the control section is configured to:
acquire information about start and end of operation of a load included in the second voltage subsystem, and
calculate the power consumption value in the second voltage subsystem based on the information about the start and end of the operation.

12. The power conversion device according to claim 8,
wherein the control section is configured to:
acquire information about start and end of operation of a load included in the second voltage subsystem, and
calculate the power consumption value in the second voltage subsystem based on the information about the start and end of the operation.
